(19) United States
(12) Patent Application Publication
(10) Pub. No.: US 2026/0079767 A1
(43) Pub. Date: Mar. 19, 2026

(54) METHOD OF DYNAMICALLY BALANCING VOLTAGE AND FREQUENCY WITH PERFORMANCE IN PROCESSING UNITS AND PROCESSING UNITS ADAPTED FOR SAME

(71) Applicant: ADEIA SEMICONDUCTOR TECHNOLOGIES LLC, San Jose, CA (US)

(72) Inventors: Kuo An Chao, Burbank, CA (US); Seung Kang, San Diego, CA (US)

(21) Appl. No.: 18/890,672

(22) Filed: Sep. 19, 2024

(51) Int. Cl. G06F 9/50; G06F 1/20

(52) U.S. Cl. CPC G06F 9/5094; G06F 1/20; G06F 9/505

(57) ABSTRACT

Disclosed are system and methods of dynamically balancing power and performance of a processing unit. The method includes receiving workloads to be processed by the processing unit; classifying, using a recurrent neural network, the workloads according to expected resources to be expended by different functional blocks; identifying a critical path workload based on the classification of workloads; determining a temperature-independent operating frequency for the critical path workload; determining a temperature-dependent operating frequency for the critical path workload based on a junction temperature of the processing unit; adjusting the temperature-dependent operating frequency to a target operating frequency having a value within a predetermined difference from the temperature-independent operating frequency by actively cooling the processing unit; setting a critical path supply voltage based on the target operating frequency; and setting a non-critical path voltage for remaining ones of the workloads at a value less than the critical path supply voltage.

### TECHNICAL FIELD

This disclosed technology generally relates to a method of dynamically balancing voltage and frequency with performance in semiconductor integrated circuit (IC) devices and, more particularly to implementing the method in a processing unit configured for machine learning based on real-time sensor data, and to processing units configured for such methods.

### BACKGROUND

Semiconductor integrated circuit (IC) devices have numerous applications, including consumer electronics, industrial applications, communication applications, and cloud system applications, to name a few. The semiconductor IC devices include various types of processing units designed to perform data processing and computation in accordance with commands or instructions for processing workloads. The processing units include general-purpose central processing units (CPUs), which are generally adapted for executing one or few instructions at a time, and memory, which is generally adapted for storing data. Different operations (and also the performance of such processing units) can cause different amounts of power consumption by the processing units. For example, when the processing units process different workloads, the processing units may utilize different amounts of computational resources (and also storage resources) to process the different workload. Despite technological advancements in semiconductor IC devices, the ongoing demand for optimizing power consumption continues to present technical challenges. Current trends in semiconductor technology demand handling increasing workloads while improving energy efficiency (e.g., reducing power consumption of the semiconductor IC device) and employing innovative power management techniques (e.g., dynamically scaling supply voltage based on computational demands). Since power consumption is directly proportional to the utilization of processing units, there is a need for systems and methods that optimize power usage (e.g., supply power) based on the execution of each application. Therefore, improved semiconductor IC devices are needed to meet these demands.

### SUMMARY

In one aspect, a method of dynamically balancing power and performance of a processing unit configured for machine learning based on real-time sensor data comprising receiving a plurality of workloads to be processed by the processing unit; classifying, using a recurrent neural network, the workloads according to expected resources to be expended by different functional blocks of the processing unit; identifying a critical path workload based on the classification of workloads; determining a temperature-independent theoretical operating frequency for the critical path workload; determining a temperature-dependent operating frequency for the critical path workload based on a calculated junction temperature of the processing unit, the calculated junction temperature determined from a temperature sensor coupled to the processing unit; adjusting the temperature-dependent operating frequency to a target operating frequency having a value within a predetermined difference from the temperature-independent theoretical operating frequency by actively cooling the processing unit using a cooling unit coupled to the processing unit; setting a critical path supply voltage based on the target operating frequency; and setting a non-critical path voltage for remaining ones of the workloads at a value less than the critical path supply voltage.

In another aspect, an integrated circuit (IC) device comprises a computing unit, a cooling component, a controller, and a memory unit. The computing unit comprises a processing unit comprising a plurality of functional blocks and a sensor array module comprising at least a temperature measurement sensor and a leakage power measurement sensor. The cooling component is configured to manage the temperature of the processing unit. The controller comprises a cooling controller circuitry and a voltage scaling circuitry. The memory unit is communicatively coupled with the computing unit and the controller, and the memory unit includes stored thereon instructions to perform classifying, using a recurrent neural network stored in the memory unit, a plurality of workloads to be processed by the processing unit according to expected resources to be expended by different functional blocks of the processing unit; selecting a target workload from the plurality of workloads based on classification results of the plurality of workloads; identifying a critical path within the plurality of functional blocks; determining a temperature-independent theoretical operating frequency for the one or more functional blocks; determining a temperature-dependent operating frequency for the one or more functional blocks based on calculated junction temperature of the processing unit and a total power consumption of the processing unit; adjusting, by managing the temperature of the processing unit using the cooling component, the temperature-dependent operating frequency to a target operating frequency having a value within a predetermined difference from the temperature-independent theoretical operating; setting, using the voltage scaling circuitry, a critical path supply voltage based on the target operating frequency, the critical path supply voltage supplied to the one or more functional blocks; and setting, using the voltage scaling circuitry, a non-critical path supply voltage for remaining functional blocks at a value less than the critical path supply voltage. The critical path includes one or more functional blocks utilized to process the target workload. The calculated junction temperature is determined by the temperature sensor, and the total power consumption includes leakage power detected by the leakage power detection sensor.

### BRIEF DESCRIPTION OF THE DRAWINGS

The following detailed description of illustrative embodiments is better understood when read in conjunction with the appended drawings. For the purpose of illustrating the present disclosure, exemplary constructions of the disclosure are shown in the drawings. Moreover, those skilled in the art will understand that the drawings are not to scale. Wherever possible, like elements have been indicated by identical numbers. The detailed description of embodiments and the embodiments set forth in the drawings present various descriptions of specific embodiments of the invention. However, the invention can be embodied in a multitude of different ways. It will be understood that certain embodiments can include more elements than illustrated in a drawing and/or a subset of the elements illustrated in a drawing. Further, some embodiments can incorporate any suitable combination of features from two or more drawings. The present disclosure is not limited to specific methods and apparatus disclosed herein.

FIG. 1 is an example of a semiconductor device, according to embodiments disclosed herein.

FIG. 2 is a block diagram of a processing unit, according to an embodiment.

FIG. 3 is a block diagram of a system for dynamically balancing power and performance of a processing unit, according to an embodiment.

FIG. 4 is a process for performing dynamic power and performance balancing, according to an embodiment.

FIG. 5 is a process for processing incoming workloads, according to an embodiment.

FIG. 6 is a process for identifying critical path functional blocks, according to an embodiment.

FIG. 7 is a process for determining temperature-dependent operating frequency, according to an embodiment.

FIG. 8 is a process for adjusting temperature-dependent operating frequency to a target operating frequency, according to an embodiment.

FIG. 9 is an alternative process for performing dynamic voltage and frequency scaling, according to an embodiment.

### DETAILED DESCRIPTION

Although several embodiments, examples, and illustrations are disclosed below, it will be understood by those of ordinary skill in the art that the disclosure described herein extends beyond the specifically disclosed embodiments, examples, and illustrations and includes other uses of the disclosure and obvious modifications and equivalents thereof. Embodiments are described with reference to the accompanying figures, wherein like numerals refer to like elements throughout. The terminology used in the description presented herein is not intended to be interpreted in any limited or restrictive manner simply because it is being used in conjunction with a detailed description of some specific embodiments of the disclosure. In addition, embodiments can comprise several novel features. No single feature is solely responsible for its desirable attributes or is essential to practicing the disclosure herein described.

The semiconductor industry is witnessing a growing demand for increased computational resources, driven by the need for higher performance to handle expanding workloads and the exponential growth of data. This trend is particularly evident in areas such as artificial intelligence (AI), machine learning (ML), high-performance computing (HPC), and cloud systems, all of which require substantial processing power to manage big data (e.g., metadata) for various applications. In response, the industry has focused on developing semiconductor devices with higher transistor densities to boost computational performance while also optimizing power consumption. One key approach to balancing the increasing demands for performance and power efficiency has been the implementation of dynamic voltage and frequency scaling (DVFS) systems, which adjust supply voltage and operating frequency based on real-time workload requirements. However, some traditional DVFS systems face several technical limitations. For instance, they offer limited voltage and frequency scaling ranges, providing only discrete, pre-set options. This can lead to overestimation or underestimation of the voltage and frequency needed by the semiconductor device, resulting in suboptimal performance or excessive power consumption. Additionally, some traditional DVFS systems scale voltage and frequency based on application-specific requirements, meaning they rely on pre-set values rather than dynamically adjusting in real time. This becomes problematic when handling workloads that fluctuate in complexity, such as those generated by AI or ML applications, where data processing demands can vary rapidly. As a result, some traditional DVFS systems struggle to adapt to real-time changes in workload intensity, limiting their ability to efficiently optimize performance and power consumption in modern semiconductor devices.

### Overview of Semiconductor IC Device Implementing Dynamic Power-Performance Balancing Unit

Semiconductor integrated circuit (IC) devices include various IC device components, including various types of processors and memories. The memories can include random-access memories (RAM), e.g., dynamic RAM (DRAM) or static RAM (SRAM), and/or storage or nonvolatile memories such as flash memory. The processors can include general-purpose central processing units (CPUs), which are generally adapted for executing one or few instructions at a time, tensor processing units (TPUs), which may be specially adapted for handling the demanding computations for training neural networks, such as deep learning tasks, and graphics processing units (GPUs), which contain hundreds or thousands of co-processors that compute instructions in parallel. The IC device components also include various logic circuitry to perform logical operations. Generally, the semiconductor compute IC device components are integrated on a chip or a semiconductor die, such as integrated as a system-on-chip.

For the purposes of this description, an integrated semiconductor IC component (e.g., components integrated on a chip or semiconductor die) may be referred to as a processing unit. As disclosed herein, a processing unit can include one or more sub-sections, generally referred to herein as functional blocks. Each functional block in turn includes one or more semiconductor components (e.g., a group of semiconductor components) that perform specific tasks within the processing unit. These functional blocks may include, but are not limited to, a computing block, one or more memory blocks, a control block, a logic block, and one or more interface blocks. While specific semiconductor components or integrated circuits (ICs) are described in connection with the various embodiments disclosed herein, the present disclosure does not limit the number or types of semiconductor components used. The number and type of components can vary based on specific applications and design requirements.

Each functional block within the processing unit consumes power to enable its IC device components included therein to perform their respective tasks (e.g., executing instructions, managing data flow, etc.). The performance of these blocks can generally be directly correlated with power consumption, where higher operating frequency results in greater power usage. Operating frequency refers to the speed at which a block executes its operations, specifically, the number of operations the block can perform per second. The operating frequency and power consumption of the processing unit are typically optimized to enhance overall efficiency. For instance, increasing performance (e.g., by raising the operating frequency) will lead to increased power consumption, thus requiring a balance between performance and power efficiency to optimize the processing unit's operation.

Optimizing the performance and power efficiency of the processing unit is a key aspect of modern processor design. Today's technology trends show an increasing density of semiconductor IC components (including functional blocks) to handle complex tasks that demand high performance, such as AI and machine learning (ML) workloads. At the same time, the form factor of these processing units is shrinking to enable their integration into a wide range of mobile devices, such as tablets, laptops, smartphones, earphones, wearable devices like smart rings, and more.

In the relevant technical field, dynamic voltage and frequency scaling (DVFS) systems are generally implemented in semiconductor IC devices to manage both the performance and power consumption of the processing unit. Specifically, in current DVFS systems, voltage (supply voltage) and frequency adjustments are made dynamically based on the workloads required to execute one or more applications. For example, the DVFS system may scale down the voltage and frequency during low workloads to save power and scale them up during high workloads to boost performance.

However, traditional DVFS systems face technical limitations in effectively balancing performance and power consumption. These systems typically rely on preset values for scaling the operating frequency and supply voltage (e.g., supply power to the processing unit) based on specific workload profiles. As a result, when workloads fluctuate—such as when an application like image processing adjusts resolution or receives varying inputs—the system's ability to optimize power and performance can be constrained. Some DVFS system can be limited to respond only to the predefined values set for specific workloads, which can lead to inefficiencies when workload demands are constantly changing. For instance, in an application where input parameters such as image resolution vary dynamically, traditional DVFS systems may struggle to adjust the operating frequency and power consumption effectively because it operates based on preset scaling values rather than real-time workload variations

In addition, some traditional DVFS systems perform voltage and frequency scaling across the entire processing unit. For example, these systems adjust the supply voltage and operating frequency uniformly for the entire processing unit. This approach can lead to inefficiencies in balancing power consumption and performance because different functional blocks within the processing unit may have varying performance requirements. Some functional blocks may require a lower operating frequency than others, but some traditional DVFS systems may apply the same scaling to all functional blocks, without considering the specific performance needs of each block for processing particular workloads. This can result in suboptimal resource allocation and power management. In addition, some traditional DVFS systems ramps voltage and operating frequency across the processing unit, where each functional block of the processing unit may have different requirements of the ramping. Such higher ramping rate to the functional blocks, having slower ramping rates requirement than the ramping rates of the other functional blocks, can generate spikes in voltage and operating frequency to these functional blocks. Such spikes can stress the components included in these functional blocks, causing a sudden over-voltage and over-frequency that exceed the strain in these components (e.g., the strain can be determined based on the material of the components).

Furthermore, some traditional DVFS systems scale the operating frequency and supply voltage of the processing unit without adequately considering the thermal effects on its performance. Typically, increasing the operating frequency leads to a rise in the junction temperature, which refers to a temperature in the active regions of a semiconductor device. For example, a junction temperature can refer to a peak temperature in transistors during operation of the IC device components. This increase in junction temperature can result in higher power dissipation by the semiconductor devices due to various factors. For example, the increase in junction temperature can result in higher leakage currents, e.g., transistor gate and junction leakage currents that may be thermally activated, which, in turn, lead to further power consumption by the processing unit. For instance, when the operating frequency is increased (e.g., by raising the supply voltage), the junction temperature also rises, thereby causing an increase in leakage current. As a result, when traditional DVFS systems scale the frequency to a target operating frequency, the actual operating frequency achieved is lower than the target operating frequency due to thermal effects, while the power consumption of the processing unit is higher than expected.

To address these and other needs of the semiconductor IC device, aspects of the present disclosure provide various embodiments of a novel power-performance balance systems and methods adapted for dynamic scaling frequency and voltage of a processing unit by utilizing a machine learning model and analyzing thermal profile of the processing unit.

In various embodiments, the disclosed power-performance balance system is designed to optimize the voltage and frequency of each functional block within the processing unit by analyzing incoming workloads and determining the expected resource usage for each block to handle those workloads. The system may incorporate a machine learning model to predict incoming workloads and classify the functional blocks accordingly. The machine learning model is trained to identify the functional blocks expected to process the incoming workloads and determine the demanded performance (e.g., operating frequency) for each of these blocks.

In some embodiments, the machine learning model can be trained using historical application usage data to predict future workloads. The historical application usage data may be associated with how a particular user has used the application in the past. It can anticipate application execution over specific time intervals, such as every second, minute, or hour, or at any other predefined interval. In some examples, the model classifies functional blocks based on their expected relative usage load in processing the incoming workloads. Additionally, the model can identify which functional block(s) are likely to expend resources on the incoming workloads. As described herein, the functional blocks(s) that are expected to expend the most amounts of resources and can therefore serve as a bottleneck, either in terms of resources and/or time, are referred to as critical path functional block(s). For example, if fetching information from a memory device serves as the bottleneck in completing the workload, the memory device can be the critical path functional block. Similarly, if performing logical operations using a microprocessor serves as the bottleneck in completing the workload, the microprocessor can be the critical path functional block.

In some embodiments, the machine learning model can prioritize the incoming workloads based on expected usage of functional blocks to perform each workload. As described herein, the functional blocks utilized to process the prioritized workload can be identified critical path functional blocks, and the functional blocks utilized for processing the non-prioritized workloads can be the non-critical path functional blocks. Thus, the power-performance balance system as disclosed herein can adaptively scale the operating frequency and supply voltage based on the workload. For example, when the processing unit is processing the prioritized workload, the power-performance balance system can increase the operating frequency and/or supply voltage to the functional blocks while processing the prioritized workload. Then, when the processing unit is processing the non-prioritized workload, the operating frequency and/or supply voltage supplied to the functional blocks can be decreased.

In some embodiments, a machine learning model can be trained to assess the performance needs of each critical path functional block to handle incoming workloads. The training process may utilize historical data related to the usage of these critical blocks to complete tasks associated with similar workloads. For the purpose of the present description, the results of assessment of the performance (that needs of each critical path functional block to handle incoming workloads) is referred to as a temperature-independent operating frequency of the critical path functional blocks.

The machine learning model disclosed herein can also be referred to as a workload classification and prediction model (for the purpose of description). In some embodiments, this model can include a recurrent neural network (RNN), designed to predict sequences of data such as incoming workloads (e.g., expected workloads), classify functional blocks for each workload, and predict the expected usage of each block to process tasks associated with the workloads. The RNN may include a plurality of nodes where each node stores temporal sequence data, allowing the output of each sequence to be continuously updated based on the previous output. For example, the predicted incoming workloads are stored in these nodes, and the predicted usage of functional blocks to process the workload is updated based on historical usage patterns. The RNN can also track changes in any temporal sequence and continuously update its parameters (e.g., for predicting incoming workloads and functional block usage).

Various machine learning models, either as standalone models or in combination with the RNN, may be used in different embodiments. These models can include large language models, supervised learning models, unsupervised learning models, semi-supervised learning models, reinforcement learning models, deep learning models, and/or ensemble learning models. Other models, such as logistic regression models, decision trees, random forests, convolutional neural networks (CNNs), and deep networks, can also be utilized. Additionally, alternative models such as linear regression, discrete choice models, or generalized linear models may be applied depending on the requirements.

The machine learning algorithms can be configured to adaptively develop and update these models over time based on new input data. Non-limiting examples of machine learning algorithms include supervised and unsupervised learning algorithms, such as regression algorithms (e.g., Ordinary Least Squares Regression), instance-based algorithms (e.g., Learning Vector Quantization), decision tree algorithms (e.g., classification and regression trees), Bayesian algorithms (e.g., Naive Bayes), clustering algorithms (e.g., k-means clustering), association rule learning algorithms (e.g., a priori algorithms), artificial neural networks (e.g., Perceptron), deep learning algorithms (e.g., Deep Boltzmann Machine), dimensionality reduction algorithms (e.g., Principal Component Analysis), and ensemble algorithms (e.g., Stacked Generalization).

In various examples, the power-performance balancing system disclosed herein can perform thermal analysis to evaluate the impact of temperature on the performance of the processing unit. The system can determine performance degradation caused by thermal effects, such as by analyzing the junction temperature and the leakage power. The correlation between leakage power and performance degradation can be referred to as temperature-dependent operating frequency, which reflects the degraded performance (e.g., reduced operating frequency) due to thermal effects.

In some embodiments, the power-performance balance system can adjust the temperature-dependent operating frequency to optimize the scaling of voltage and frequency for the functional blocks, particularly the critical path functional blocks. The semiconductor device may include a cooling mechanism designed to control the thermal profile of the processing unit. The system can adjust the temperature-dependent operating frequency to a target operating frequency, which approximates the thermal-independent operating frequency (e.g., the operating frequency unaffected by thermal constraints). For the purpose of description, the target operating frequency is defined as either equal to or within a predefined threshold range of the thermal-independent operating frequency.

In some embodiments, the power-performance balance system can dynamically scale the performance of each functional block in real-time or near real-time based on the incoming workloads. The system may scale the frequency and/or voltage of critical path functional blocks to the target operating frequency (or within a predefined frequency range) while scaling the frequency and voltage of the remaining functional blocks to a lower level—e.g., 5%, 10%, 15%, 20%, 25%, 30%, 35%, 40%, 45%, or 50% below the target operating frequency, or a value in a range that can be determined by any of these values.

In various examples, the power-performance balance system can scale the operating frequency and voltage of the functional blocks (both critical path and non-critical blocks) at a predefined ramping rate. Each functional block may have different ramping rate requirements, and scaling the frequency and voltage according to these requirements can prevent sudden voltage and frequency spikes that could cause physical stress on the components.

To facilitate an understanding of the systems and methods discussed herein, several terms are described below. These terms and other terms used herein should be construed to include the provided descriptions, the ordinary and customary meanings of the terms, and/or any other implied meaning for the respective terms, wherein such construction is consistent with the context of the term. Thus, the descriptions below do not limit the meaning of these terms but only provide example descriptions.

A central processing unit (CPU) can refer to a processing component that performs the processing of data by executing instructions, such as performing basic arithmetic, logic control, and input/output operations in accordance with the instructions. The CPU can have various architectures that dictate how the CPU processes data, executes instructions and communicates with other parts of the computer system. However, the present disclosure does not limit the CPU architectures.

A tensor processing unit (TPU) can generally refer to a processing unit (e.g., a type of application-specific integrated circuit) specifically designed for accelerating machine learning workloads, such as handling computational requirements of machine learning models (for example, a deep learning algorithm). The TPU can include, without limiting, matrix multiplication units configured to perform matrix multiplications in accordance with the machine learning models, memory configured to support data transfer demanded for machine learning workloads, and the like.

A neural processing unit (NPU) can generally refer to a processing unit specifically designed for accelerating machine learning and artificial intelligence computations that involve neural networks. For example, the neural network can generally refer to a network having a plurality of nodes and layers, where each node (organized in specific layer(s)) processes data to perform the task, such as data patter reorganization, data classification, output predictions, and the like. The NPU is designed to perform specific types of mathematical operations used in the neural network. The NPU can include a plurality of processing cores configured to execute multiple operations in the neural network parallelly.

A graphics processing unit (GPU) can refer to a processing unit designed to accelerate graphics rendering. The GPU can include a plurality of cores configured to perform parallel processing. The GPU can have various architectures based on its operation, such as parallel processing. In addition, the GPU can be implemented as a stand-alone processing unit or integrated with other processing units, such as the CPU. The present disclosure does not limit the types of GPU architecture and implementation of the GPU.

A functional block can include one or more IC device components configured to perform a particular operation. For example, each functional block can be configured to perform a particular operation, such as a computing operating, a data storage operation, a temporary data storage operation, a data flow (e.g., logic) operation, an input-output interface operation, and the like. While the present disclosure illustrates and discloses certain operations and types of functional blocks, these illustrations are provided as examples without limitation. Furthermore, the types of functional blocks implemented in the processing unit may be determined based on specific applications and their related workloads, and the present disclosure does not limit such applications and workloads.

An ambient temperature can refer to the temperature of the surrounding environment of the processing unit.

A junction temperature can refer to a temperature representative of a processing unit or functional block in operation. In particular, a junction temperature can be representative of active regions of a semiconductor device integrated as part of the processing unit or functional block. For example, a junction temperature can be or be representative of a peak temperature in transistors during operation of the IC device components. The junction temperature can further represent such temperature under a thermal equilibrium or steady state. In operation, the junction temperature can reach an equilibrium or steady state temperature, such that the heat in the active region of the semiconductor device is dissipated to the surrounding environment of the processing unit, and the temperature difference between the active region (e.g., junctional temperature) and the surrounding regions can reach a constant value, thereby reaching a steady state.

A cooling component can generally refer to a cooling mechanism of the semiconductor device utilized to cool the processing unit. The cooling component, as disclosed herein, can include active cooling components that the operation of the cooling mechanism can be actively controlled. In non-limiting examples, the cooling component can include fans, where the speed of fans can be controlled, a liquid cooling, where the circulation of the coolant included in this cooling component can be controlled, a thermoelectric coolers, where the temperature of the steady state device that generates the low temperature can be controlled, or phase-change coolers, where the performance of refrigerants (e.g., the amount of evaporation) can be controlled.

Semiconductor IC Device with Enhanced Power-Performance Balance System

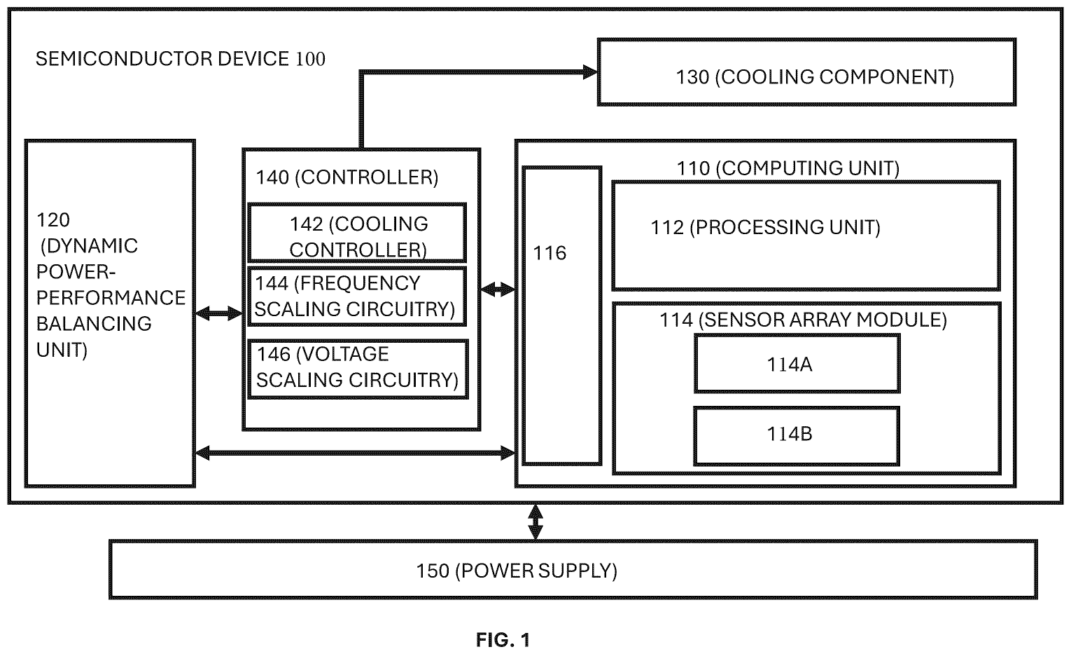

FIG. 1 illustrates a semiconductor IC device 100 incorporating a dynamic power-performance balancing unit 120, which may also be referred to herein as an advanced or enhanced power-performance balance unit. The dynamic power-performance balancing unit 120 can dynamically adjust one or both of the voltage and frequency by analyzing thermal effect on the processing unit 112 to optimize performance and power efficiency, as disclosed herein. Among other things, the dynamic power-performance balancing unit 120 can perform improved dynamic voltage and frequency scaling operations using electro-thermally coupled neural networks coupled with integrated sensors, as disclosed herein. As illustrated, the semiconductor IC device 100 comprises the dynamic power-performance balancing unit 120, a computing unit 110, a cooling component 130, and a controller 140. The computing unit 110 and dynamic power-performance balancing unit 120 are directly coupled (e.g., electrically connected), allowing real-time adjustments of performance parameters based on workload demands. The dynamic power-performance balancing unit 120 and the controller 140, as well as the computing unit 110 and controller 140, are also electrically connected, forming an integrated system. In certain embodiments, the cooling component 130 is also electrically connected to the controller 140 to facilitate thermal management.

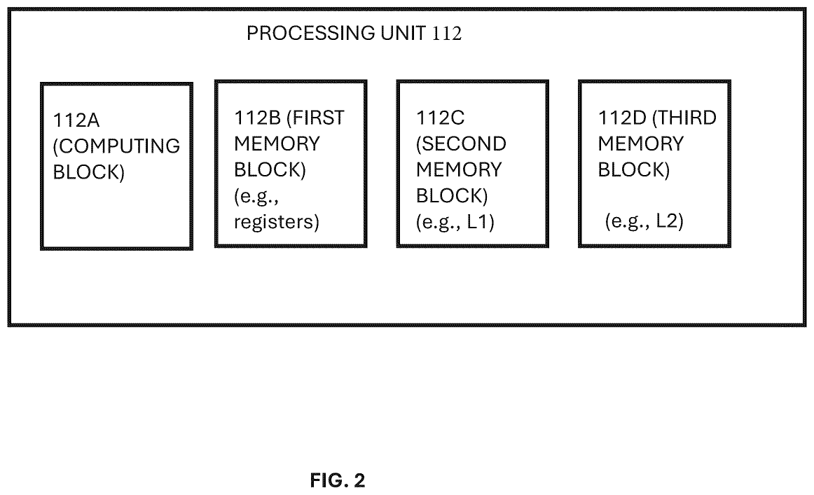

The computing unit 110 includes a processing unit 112 and a sensor array module 114. The processing unit 112 may incorporate various processing elements, such as central processing units (CPU), graphics processing units (GPU), neural processing units (NPU), and tensor processing units (TPU), configured to handle diverse computational tasks. Each of these processing elements contains multiple functional blocks (detailed in FIG. 2), and they are responsible for executing commands and managing workloads. The functional blocks may be fabricated as part of a die on a semiconductor substrate, allowing for compact and efficient integration. The computing unit 110 can include an interface 116. The interface 116 can be a physical interface to connect to the dynamic power-performance balancing unit 120 and the controller 140 and serves as the conduit that communicate data, such as instructions provided from the dynamic power-performance balancing unit 120 (e.g., the instructions to be executed by the processing unit 112), the frequency scaling and voltage scaling instructions provided from the controller 140, and/or the data generated from the sensor array module 114 (e.g., measured ambient temperature and/or leakage power) to the dynamic power-performance balancing unit 120.

The sensor array module 114 is configured for monitoring the operational environment within the semiconductor device. It includes several sensors, such as a temperature sensor 114A and a leakage power monitoring sensor 114B, both of which may be fabricated on a single die, referred to as a global die. This global die monitors key performance metrics across the processing unit. In embodiments with multiple processing units (e.g., 5 processing units 112 for parallel processing), one or more global dies can be distributed between the units to measure thermal and leakage power metrics. This ensures that the dynamic power-performance balancing unit 120 can adapt to changing conditions, such as heat dissipation and power consumption, in real-time. The number of processing units and global dies can vary based on design needs, with the present disclosure not limiting the configuration to specific values or types of sensors.

The controller 140 is configured to perform various operations within the semiconductor device 100. In some examples, the controller 140 comprises a cooling controller 142, a frequency scaling circuitry 144, and a voltage scaling circuitry 146.

The cooling controller 142 is responsible for managing the cooling component 130, which may be one or more fans, liquid cooling systems, or thermoelectric coolers. The controller 142 adjusts operational parameters such as fan speed, coolant flow rate, or thermal dissipation to maintain optimal operating temperatures within the computing unit 110. In more advanced configurations, the cooling controller 142 can modulate coolant flow in response to real-time thermal effects on the functional blocks of the processing unit 112 provided by the dynamic power-performance balancing unit 120 in accordance with embodiments disclosed herein. For instance, the coolant speed can be increased to rapidly dissipate heat during intensive workloads, ensuring thermal stability and preventing performance throttling.

The frequency scaling circuitry 144 dynamically adjusts the operating frequency of each functional block within the processing unit 112. This adjustment is accomplished by controlling the reference clock signals supplied to these blocks. In some embodiments, the frequency scaling circuitry 144 can generate multiple reference clock signals. The frequency scaling circuitry may incorporate advanced clock generators such as phase-locked loops (PLLs) and delay-locked loops (DLLs), which provide precise and stable clock signals. The control logic in the frequency scaling circuitry 144 can increase or decrease the clock frequency in response to workload changes, maximizing performance during intensive tasks and reducing power consumption during idle or low-demand periods. This ability to scale frequency enhances both efficiency and thermal management.

The voltage scaling circuitry 146 dynamically adjusts the supply voltage to each functional block. By modulating the input voltage from the power supply 150, the voltage scaling circuitry can precisely control the power delivered to individual components. In some embodiments, the voltage scaling circuitry 145 can generate multiple voltages. The voltage scaling circuitry typically includes voltage regulators, such as low-dropout (LDO) regulators and switching regulators (e.g., DC-DC converters), which are selected based on the specific voltage and current requirements of the processing unit. These regulators ensure that each functional block receives the optimal voltage level for its operating conditions. For instance, higher operating frequencies typically may need increased supply voltages, while lower frequencies allow the voltage to be reduced, leading to significant power savings.

In some embodiments, the frequency and voltage scaling are coupled. For example, increasing the clock frequency is often achieved by an increase in supply voltage to maintain stability and performance. The frequency scaling circuitry 144 and voltage scaling circuitry 146 work in unison, with the dynamic power-performance balancing unit 120 simultaneously adjusting both parameters to deliver the necessary performance while minimizing power consumption. In complex systems, the power-performance balance system may contain multiple clock generators and voltage regulators to independently scale different functional blocks, allowing for fine-grained control over power and performance across the entire processing unit 112.

The power supply 150 is external to the semiconductor device and provides input power to the system. This could be sourced from power grids, batteries, or other forms of external power sources. The specific type of power supply depends on the application and the intended environment for the semiconductor device. The flexibility in power supply options allows the device to be used in various applications, from portable electronics to high-performance computing systems.

### Variations and Configurations of the Semiconductor Device

In some embodiments, the semiconductor device 100 may also include a memory unit (not shown in FIG. 1) comprising a memory cell array block, a physical layer (PHY), and a memory logic block. The memory unit is connected to the computing unit 110 via physical interface 116 and acts as data storage for the system. The memory cell array block can include both a volatile memory (e.g., DRAM for temporary data storage) and a non-volatile memory (e.g., flash memory for permanent data storage), providing flexibility depending on the system's memory needs. The present disclosure does not limit the type or configuration of memory used in the memory unit.

Even though each component of the semiconductor device 100, such as the dynamic power-performance balancing unit 120, computing unit 110, controller 140, and cooling component 130, is illustrated as a standalone sub-device, the present disclosure is not limited to this implementation. Various alternative configurations are possible, with components being integrated or distributed differently depending on design requirements.

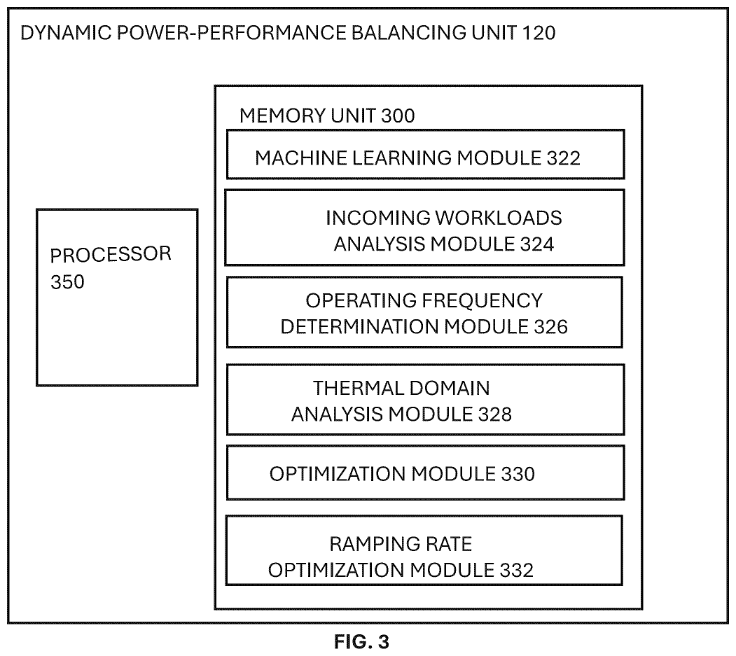

In certain implementations, the dynamic power-performance balancing unit 120 may be incorporated into a memory module (e.g., memory unit 300 in FIG. 3), which stores multiple modules responsible for executing power-performance balance system instructions. This memory can be non-volatile, ensuring that critical performance configurations are preserved even when the device is powered off. Alternatively, these modules could be stored in the memory array block of the memory unit.

In other configurations, the dynamic power-performance balancing unit 120 may include a dedicated processor that controls the various scaling parameters in real-time. This dedicated processor, which could be fabricated on the same substrate as the controller 140, would execute the instructions stored in memory and manage the frequency and voltage scaling of the semiconductor device in response to performance demands.

The computing unit 110 may also provide dedicated resources for storing and executing the power-performance balance system modules, ensuring seamless performance scaling across all functional blocks.

### Processing Unit

In some embodiments, the processing unit 112 can include multiple functional blocks, where each block can be a distinct block designed to perform specific tasks related to the processing unit's overall operation. These functional blocks can be made up of interconnected semiconductor components, such as, without limitation, an arithmetic logic unit (ALU), a cache memory, a main memory, an input and output (I/O) device, a bus, a control unit, and an instruction set architecture (ISA), arranged to execute logical computations according to the block's designated function. These blocks collectively enable the processing unit 112 to efficiently handle various workloads.

FIG. 2 provides an example of the processing unit 112, which includes several functional blocks, including a computing block 112A and various memory blocks including first memory block 112B, second memory block 112C, and third memory block 112D.

The computing block 112A can be comprised of several sub-units, each optimized for specific computational tasks. One key unit within the computing block can be the arithmetic logic unit (ALU), which handles all arithmetic operations (such as addition, subtraction, multiplication, and division) as well as logical operations (such as AND, OR, and XOR). The ALU is constructed from multiple logic gates and adders that process data in a sequential or parallel fashion, depending on the architecture, and ensures rapid execution of integer-based calculations that are crucial for general-purpose processing tasks.

Another component of the computing block 112A is a control unit, which manages data flow within the functional blocks of the processing unit 112. The control unit decodes instructions received from higher-level systems, such as the dynamic power-performance balancing unit 120, and directs the necessary actions for each block. By coordinating data movement and timing signals, the control unit ensures that operations are carried out in the correct sequence across different stages of the computing pipeline.

A floating point unit (FPU) within the computing block 112A is designed to handle operations involving floating-point numbers. This includes more complex mathematical functions such as floating-point addition, subtraction, multiplication, division, and square root calculations. The FPU can be optionally implemented to process workloads associated with applications that demand high numerical precision, such that the FPU is utilized to process large numerical ranges and decimal values efficiently, enabling rapid execution of floating-point calculations.

Depending on the type of processing unit, the computing block 112A may also include specialized units. For example, in GPU-based architectures, shader processors can be included to process vertex, geometry, and pixel data in parallel. These shader units are optimized for handling large datasets concurrently, which is ideal for graphics rendering tasks. On the other hand, a CPU-based processing unit might focus on arithmetic and logical operations, utilizing a smaller number of ALUs and FPUs to handle tasks serially but with high precision. The number and type of sub-units within the computing block 112A can vary depending on the intended application of the processing unit 112. For example, systems requiring high computational throughput may incorporate multiple ALUs, FPUs, and control units to handle more complex tasks simultaneously. This disclosure does not limit the types or quantity of units within the computing block 112A, allowing flexibility in design based on performance needs.

In the illustrated embodiment, the first memory block 112B, shown in FIG. 2, is implemented as a register. Registers provide high-speed storage and are used to temporarily hold data and instructions actively processed by the computing block 112A. Because of their proximity to the computing block, registers are optimized for low latency, ensuring that the ALU and FPU can quickly access operands and store results without delay. This minimizes the need for the computing block to retrieve data from slower memory systems, improving overall processing efficiency.

In the illustrated processing unit 112, the second memory block 112C includes a first level (L1) cache. This cache is larger than the register file but remains tightly integrated with the computing block 112A. The L1 cache is designed to store frequently used data and instructions, enabling faster access (slower access than the first memory block 112B). Although the latency of the L1 cache is slightly higher than that of registers, it still provides rapid data retrieval, significantly reducing the processing unit's dependency on slower external memory.

In the illustrated processing unit 112, the third memory block 112D corresponds to a second level (L2) cache. The L2 cache can provide greater storage capacity than the L1 cache but with increased latency relative thereto. It is intended to store data and instructions that are accessed less frequently but still need to be available more quickly than accessing a main memory (not shown in FIG. 2).

In various embodiments, each functional block, such as the computing block 112A and memory blocks 112B-112D, operates at a specific operating frequency. This frequency directly correlates with the performance of the block. For instance, the operating frequency of the computing block 112A reflects the rate at which it executes instructions. The speed of instruction execution is determined by the number of cycles the computing block completes per second. For example, an operating frequency of 4 GHz signifies that the computing block 112A performs 4 billion cycles per second, which directly impacts its ability to process tasks efficiently.

Similarly, the operating frequency of the memory blocks 112B-112D represents the speed at which they can transfer data or instructions to the computing block 112A. In some embodiments, each memory block may operate at a distinct frequency. For instance, the first memory block 112B, which might be used to handle a particular workload, could operate at the same frequency as the computing block 112A, while other memory blocks, such as 112C and 112D, may not engage in the same workload and thus operate at different frequencies or remain idle. In scenarios where multiple memory blocks are actively engaged, their operating frequencies may align with the computing block's frequency to optimize data transfer and reduce latency. For instance, when processing less intensive tasks, the first memory block 112B may operate at the same frequency as the computing block 112A, while the second and third memory blocks might operate at reduced frequencies to conserve power. In other scenarios, such as during high-performance tasks, all memory blocks may synchronize their frequencies with the computing block to maximize throughput and minimize latency.

Although FIG. 2 illustrates a specific number and configuration of functional blocks within the processing unit 112, this is provided merely for example purposes. For example, the functional blocks can also include an input-output block configured to receive data from external circuitry or controller, such as the controller 140 and the sensor array module 114. The functional block can also include data bus block configured to transfer data between the functional blocks of the processing unit 112. The functional block can also include an instruction set architecture configured to store various commands to be executed by the computing blocks 112A, such as data transfer instruction, arithmetic and logic instructions, control flow (sequence of execution) instructions, and the like. The present disclosure does not restrict the number or types of functional blocks that may be implemented within the processing unit. For example, more than two computing blocks 112A may be integrated to increase parallel processing capabilities, and additional or fewer memory blocks can be included depending on the system's requirements. The architecture remains flexible, allowing for the inclusion of various functional blocks as needed for specific applications.

### Power-Performance Balance System

FIG. 3 illustrates an example of a dynamic power-performance balancing unit 120 comprising a memory unit 300 configured to store various modules that provide instructions for performing power-performance balancing including, e.g., dynamic voltage and frequency scaling (DVFS), and a processor 350 configured to execute the instructions to perform the DVFS in accordance with the embodiments disclosed herein. In certain embodiments, the memory unit 300 may be implemented as a standalone memory component within the semiconductor device 100. Alternatively, the memory unit 300 can also be integrated into a specific portion of the main memory of the semiconductor device (as described with respect to FIG. 1). Furthermore, in some embodiments, the memory unit 300 could be implemented as dedicated memory within the processing unit 112, such as a non-volatile memory block. The present disclosure does not limit the specific implementation of the memory unit 300.

The memory unit 300 is configured to store instructions for various modules, each containing instructions to execute power-performance balancing including, e.g., dynamic voltage and frequency scaling in line with the embodiments described herein. The instructions stored within these modules can be executed either by the processing unit 112 or by a dedicated processor 350.

As illustrated in FIG. 3, the memory unit 300 stores instructions for several modules: the machine learning module 322, the incoming workloads analysis module 324, the operating frequency determination module 326, the thermal domain analysis module 328, the optimization module 330, and the ramping rate optimization module 332. These modules may be implemented as software modules, containing various executable instructions tailored to their specific purposes.

The machine learning module 322 comprises machine learning models, such as a Recurrent Neural Network (RNN), to predict sequences of incoming workloads, classify the functional blocks utilized (e.g., expend its resource) for each workload, and forecast the expected usage of each block to process tasks associated with these workloads. The RNN can be used to classify different workloads according to expected resources to be expended by different functional blocks of the processing unit. For example, the machine learning module 322 can predict incoming workloads based on historical application usage data, e.g., by identifying patterns and trends that can be leveraged to optimize resource allocation.

The machine learning module 322 is configured to identify a critical path among different workload level as well as within-workload. For example, among the different workloads, the workload that is expected to use the most amount of resources overall can be referred to herein as a critical path workload. The critical path workload can be expected to take the longest time and therefore considered to be a bottleneck workload among the workloads. Analogously for a given workload, the functional block that is expected to use the most amount of resources overall can be referred to herein as a critical path functional block. The critical path functional block can be expected to take the longest time and therefore considered to be a bottleneck workload among the functional blocks. Thus, based on the historical learning by the RNN, the machine learning module 322 can identify a critical path among different workloads as well as within a given workload, based on the classification of workloads.

In determining a critical path functional block, the machine learning module 322 can work in conjunction with other modules, such as the incoming workloads analysis module 324, which is configured to predict the nature and volume of incoming workloads and determining which functional blocks are corresponding to process them. In this case, the machine learning module 322 could use historical data to identify which functional blocks were previously utilized for similar workloads and predict future usage based on that information.

The incoming workloads analysis module 324 further refines this process by estimating which functional blocks will expend their resources to process incoming workloads. For instance, it can identify which functional blocks have historically been used to handle similar workloads and estimate which blocks will be necessary moving forward. The machine learning module 322 can be applied here to predict functional block usage based on past data. By utilizing RNN models, the machine learning module 322 can track and continuously update workload predictions, capturing changes in temporal sequences and adjusting its parameters accordingly. After determining the necessary functional blocks, the incoming workloads analysis module 324 designates certain blocks as critical path functional blocks. These are the blocks that are expected to handle the majority of the processing workload, such as expending resources at or above a certain threshold, such as 50% of their available capacity. In some embodiments, the threshold can be lower or higher than 50%, and this threshold can be determined based on the specific workload and its associated application.

The operating frequency determination module 326 can determine the operating frequency to be set for each critical path functional block. The operating frequency is determined based on a theoretical minimum latency for processing each workload. As described herein, such theoretical operating frequency is referred to as the temperature-independent operating frequency. This frequency represents the ideal operating speed of the critical path functional blocks, assuming little or no thermal constraints affect their performance.

The thermal domain analysis module 328 can assess the thermal impact on the critical path functional blocks. It analyzes how thermal effects, such as heat buildup, can lower the actual operating frequency of these blocks. The module provides instructions to estimate the temperature-dependent operating frequency, which accounts for the thermal conditions on the critical path functional blocks. For example, the module calculates total power consumption and junction temperature for each critical path functional block, determining if the junction temperature exceeds predefined thresholds that would cause reducing the operating frequency.

Once the thermal effects have been analyzed, the optimization module 330 generates instructions to adjust the operating conditions of the system to lower or minimize the thermal effect that causes lowering the operating frequency of the critical path functional blocks. For example, it may control the cooling component 130 (FIG. 1) to lower the ambient temperature surrounding the processing unit 112 (FIG. 1). By doing so, the junction temperature of the critical path functional blocks can be reduced, allowing the temperature-dependent operating frequency to increase and approach the temperature-independent operating frequency. This optimization minimizes performance degradation caused by thermal constraints, ensuring that the critical path functional blocks maintain high performance while reducing power consumption.

After addressing thermal concerns, the ramping rate optimization module 332 adjusts the scaling of one or both of the frequency and voltage across the functional blocks. This module optimizes the ramping rate to prevent sudden changes in voltage or frequency, which could otherwise cause physical stress on the semiconductor components. The ramping rate is pre-defined based on the specifications of the semiconductor components within each functional block to ensure safe and efficient scaling.

In some embodiments, the ramping rate optimization module 332 prioritizes the critical path functional blocks by scaling their frequency and voltage higher than the remaining functional blocks. This dynamic scaling to each functional block can allow for efficient power distribution across the processing unit, allocating more resources to functional blocks that demand higher utilization while reducing resources for blocks that are less active. This approach optimizes overall system performance, ensuring that the critical path functional blocks receive the necessary power and operating frequency to handle demanding tasks, while lower-priority blocks consume less power.

In alternative embodiments in which the machine learning module 322 is used to determine a critical path functional block, the incoming workloads analysis module 324 can prioritize the workloads based on based on expected usage of functional blocks to perform each workload. For example, the workload that demands the highest utilization of the processing unit resources can be classified as the prioritized workload and other workloads can be classified as non-prioritized workloads. In some cases, the functional blocks utilized to process the prioritized workload can be referred to as critical path workload functional blocks, while the functional blocks utilized to process the non-critical path workloads (e.g., remaining workloads) can be referred to as non-critical path workloads functional blocks.

In the alternative embodiments, the operating frequency determination module 326 can determine the operating frequency to be set for the critical path workload functional blocks. The operating frequency is determined based on a theoretical minimum latency for processing the prioritized workload, referred to as the temperature-independent operating frequency.

Further in the alternative embodiments, the thermal domain analysis module 328 can assess the thermal impact on the critical path workload functional blocks. It analyzes how thermal effects, such as heat buildup, can lower the actual operating frequency of these blocks (when processing the prioritized workload). The module provides instructions to estimate the temperature-dependent operating frequency, which accounts for the thermal conditions on the critical path workload functional blocks.

Further in the alternative embodiments, once the thermal effects have been analyzed, the optimization module 330 generates instructions to adjust the operating conditions of the system to minimize the thermal effect that causes lowering the operating frequency of the critical path workload functional blocks (e.g., when processing the critical path workload functional blocks. After addressing thermal concerns, the ramping rate optimization module 332 adjusts the scaling of both frequency and voltage across the functional blocks (e.g., all functional blocks when processing the prioritized workloads, critical path workload functional blocks). This module optimizes the ramping rate to prevent sudden changes in voltage or frequency, which could otherwise cause physical stress on the semiconductor components. The ramping rate is pre-defined based on the specifications of the semiconductor components within each functional block to ensure safe and efficient scaling.

In some embodiments, the ramping rate optimization module 332 prioritizes the critical path workload functional blocks by scaling their frequency and voltage higher than the remaining functional blocks, non-critical path workload functional blocks. This dynamic scaling to functional blocks based on prioritized workloads can allow for efficient power distribution, allocating more resources to functional blocks when processing the prioritized workload while reducing resources for blocks when processing the remaining (non-prioritized) workloads.

Thus, FIG. 3 depicts a memory unit 300, capable of storing and executing various modules that enable efficient dynamic voltage and frequency scaling across the processing unit 112. The combination of machine learning-based workload predictions, thermal analysis, and optimization techniques ensures that the system maintains high performance while managing power and thermal constraints effectively. While FIG. 3 illustrates particular modules, the present disclosure does not limit the specific configuration or implementation of the memory unit 300 or the modules within the memory unit 300.

### Power-Performance Balance Method

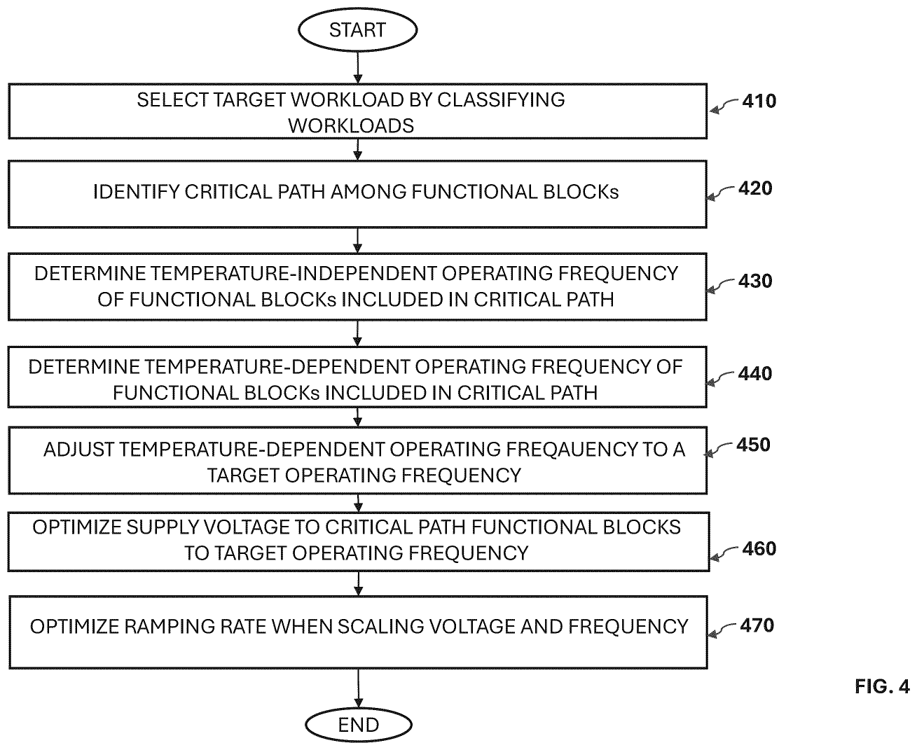

FIG. 4 illustrates a process flow diagram of performing power-performance balancing, e.g., ac dynamic voltage and frequency scaling of the functional blocks included in the processing unit 112. For the purpose of description and convenience, FIG. 4 is described with reference to FIGS. 1-3. In various embodiments, the dynamic power-performance balancing unit 120 (illustrated in FIGS. 1 and 3) can be configured to perform the process flow diagram illustrated in FIG. 4. In some examples, the process flow diagram illustrated in FIG. 4 can be repeated for each incoming workload. For example, the process flow diagram of FIG. 4 is performed for each incoming workload to be processed by the processing unit 112.

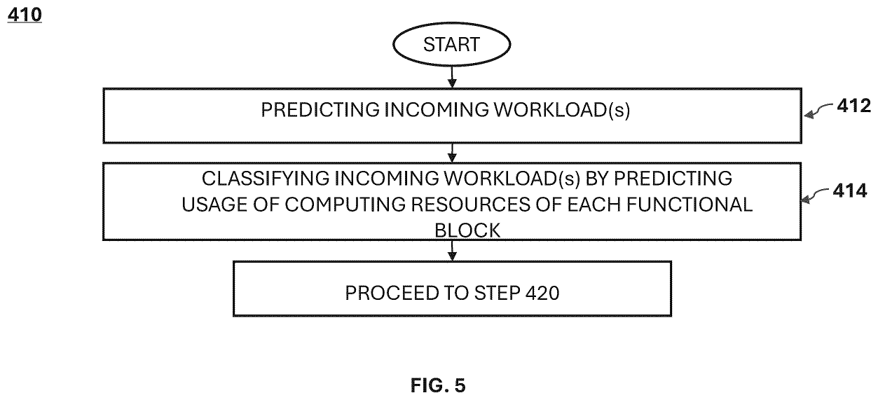

At step 410, the dynamic power-performance balancing unit 120 is used to select a target workload by classifying incoming workloads. In some cases, the step 410 (and also steps 412-414 of FIG. 5) can be performed by the processor 350 by executing instruction provided from the incoming workloads analysis module 324 and the machine learning module 322 as illustrated in FIG. 3. In some embodiments, the dynamic power-performance balancing unit 120 classifies workloads by prioritizing them according to predicted resource usage for each functional block in the processing unit 112 per individual workload. For instance, when multiple workloads arrive simultaneously, the dynamic power-performance balancing unit 120 can prioritize them based on the expected resource usage of the processing unit 112. The workload requiring the highest resource utilization among the incoming tasks is identified as the target workload. In this scenario, the dynamic power-performance balancing unit 120 can determine the appropriate operating frequency and supply voltage for the functional blocks involved in the critical path used to process the target workload. Additionally, for the other workloads, the operating frequency and supply voltage supplied to their functional blocks can be lower than those allocated to the target workload. In some embodiments, the dynamic power-performance balancing unit 120 can prioritize the incoming based on the sequence of incoming workloads. In these embodiments, the dynamic power-performance balancing unit 120 can perform the process illustrated in FIG. 4 for each incoming workload.

The process flow diagram of FIG. 5 illustrates a detailed process for classifying the workloads. At step 412, as illustrated in FIG. 5, the dynamic power-performance balancing unit 120 can predict incoming workloads. In various embodiments, the dynamic power-performance balancing unit 120 can utilize the machine learning module 322 to predict the incoming workloads. For example, the machine learning module 322 (e.g., implementing the RNN) can be trained to predict the temporal sequence of what application to be executed by the processing unit 112. In some examples, the prediction of the temporal sequence is based on historical usage of the processing unit 112. In various embodiments, each predicted application can include one or more workloads to be processed by the processing unit 112.

At step 414, as illustrated in FIG. 5, the dynamic power-performance balancing unit 120 can classify the incoming workloads by predicting expected usage of resources of each functional block. In various embodiments, predicting the expected usage of each functional block can be performed by utilizing the machine learning module 322, such that machine learning module 322 can predict the expected usage of resources of each functional block based on historical application usage data and the associated workloads such that the machine learning module 322 is configured to identify usage patterns of each functional block to be expended its resources to process each incoming workload.

In some embodiments, the dynamic power-performance balancing unit 120 can prioritize the incoming workloads per each functional block. The prioritization is based on the expected usage of each functional block. For example, if workload A is predicted to use 70% of the resources in the computing block 112A and first memory block 112B, while workload B is expected to use 60%, workload A would be prioritized over workload B. This prioritized workload is referred to as the target workload. For the purpose of present description, the prioritized workload (e.g., the workload A) can refer to as a target workload. After prioritizing the incoming workloads per functional block based on the predicted usage of each functional blocks, the process proceeds to step 420.

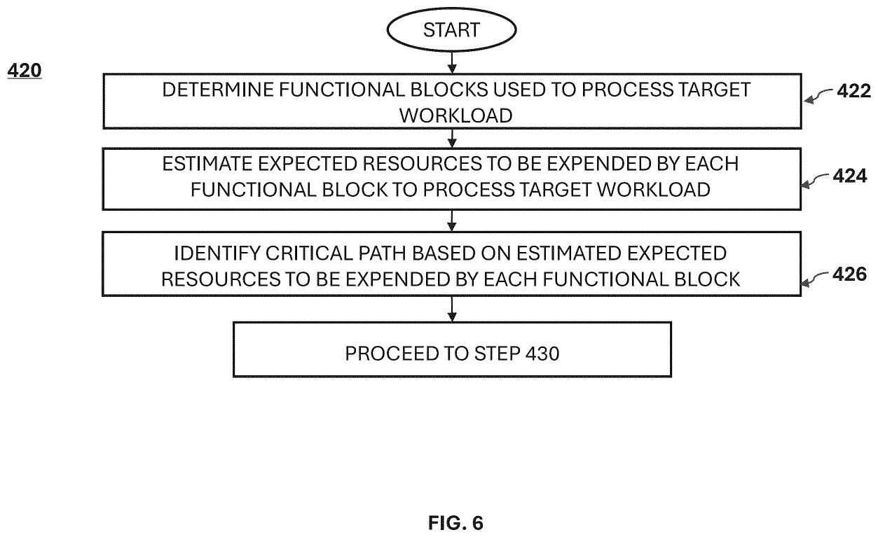

At step 420, as illustrated in FIG. 4, the power-performance balance system 120 identifies critical path among the functional blocks of the processing unit 112. In some cases, the step 420 (and also steps 422-426 of FIG. 6) can be performed by the processor 350 by executing instructions provided from the incoming workloads analysis module 324. The critical path can include the functional blocks utilized their resources to process the target workload. For example, when a target workload (e.g., prioritized workload) is utilizing resources of the computing block 112A, the first memory block 112B, and the second memory block 112C, the operating frequency utilized in these block can the same or close each other, where the third memory block 112D may not utilize its resources for processing the workload (e.g., in idle status). In this example, the critical path can include the computing block 112A, the first memory block 112B, and the second memory block 112C, and these functional blocks can be identified as critical path functional blocks. In some embodiments, the critical path can be identified based on the usage of each functional block above a threshold, such as the functional block utilizing its usage above 50% (for example without limitation) can be identified the critical path functional blocks.

The process flow diagram of FIG. 6 illustrates a detailed process for identifying critical path functional blocks. At step 422, as illustrated in FIG. 6, the dynamic power-performance balancing unit 120 can determine functional blocks used to process the target workload. For example, the dynamic power-performance balancing unit 120 can identify any functional blocks utilizing their resources to process the target workload. For example, if the target workload is computing-oriented workload, such that this target workload utilizes the computing block 112A and the first memory 112B. In this example, the computing block 112A and the first memory 112B are identified as the functional blocks used to process the target workload. In another example, the target workload is memory-oriented workload, such that the target workload utilizes the computing block 112A, the first-third memory functional blocks 112B-112D. In this example, the computing block 112A and the first-third memory functional blocks 112B-112D are identified as the functional blocks used to process the target workload.

At step 424, as illustrated in FIG. 6, the dynamic power-performance balancing unit 120 can estimate the expected resources to be expended by each determined functional blocks. For example, in the first example, when the target workload is computing centric workload, the usage of the computing block 112A and the first memory block 112B can be identified to utilize the 80% of its resources. In the second example, when the target workload is memory centric workload, the usage of the computing block 112A can be identified as utilizing 30% of its resources and the expected usage of the first-third memory blocks 112B-112D can be identified as utilizing 80% of their resources. In various examples, the usage is identified based on the historical usage data by utilizing the machine learning module 324.

At step 426, as illustrated in FIG. 6, the dynamic power-performance balancing unit 120 can identify the critical path based on the estimated expected resources to be expended by each functional block. In the first example, the computing block 112A and the first memory block 112B can be identified as the critical path, so that these two blocks are identified as critical path functional blocks. In the second example, the computing block 112A and the first-third memory blocks 112B-112D can be identified as a critical path, so that these four blocks are identified as critical path functional blocks. In other embodiments, the functional blocks utilizing its resources above a threshold, such as, for example, above 50% of its resource utilization, can be identified the critical path. In this example, the first-third memory blocks 112B-112D can be identified as the critical path, so that these three functional blocks are identified as the critical path functional blocks.

At step 430, as illustrated in FIG. 4, the dynamic power-performance balancing unit 120 determines the temperature-independent operating frequency of functional blocks included in the critical path (e.g., the critical path functional blocks identified at step 426). In some cases, the step 430 can be performed by the processor 350 by executing instruction provided from the operating frequency determination module 326. In some embodiments, the dynamic power-performance balancing unit 120 determines the minimum latency demanded for each critical path functional block to process the target workload. Such minimum latency can provide an ideal operating frequency based on the relationship that the lower minimum latency demands the higher operating frequency of the functional blocks. In various embodiments, the highest ideal operating frequency among the critical path functional blocks can be identified as the temperature-independent operating frequency.

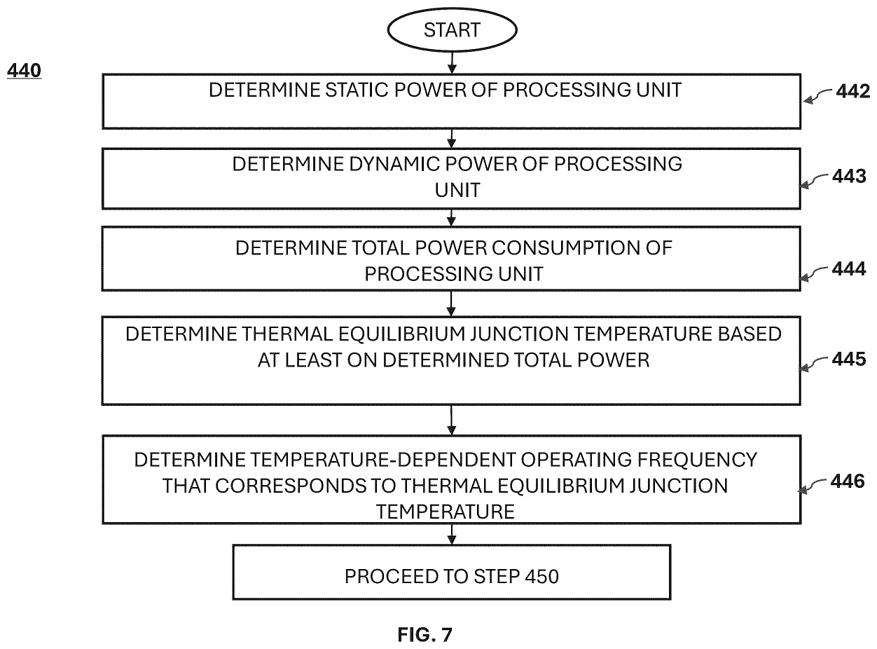

At step 440, as illustrated in FIG. 4, the dynamic power-performance balancing unit 120 determines the temperature-dependent operating frequency of the functional blocks included in the critical path (e.g., the critical path functional blocks identified at step 426). In some cases, the step 440 (and also steps 442-446 of FIG. 7) can be performed by the processor 350 by executing instruction provided from the thermal domain analysis module 328. In various embodiments, thermal effects, such as an increased junction temperature in the critical path functional blocks, can result in a reduction of their operating frequency. For instance, as the junction temperature rises, leakage power also increases due to the heat generated by the higher temperature. This increase in leakage power directly impacts the operating frequency, leading to a decrease in performance. The resulting reduced frequency is referred to as the temperature-dependent operating frequency. The process flow diagram in FIG. 7 provides a detailed explanation of how this temperature-dependent operating frequency is determined.

The process flow diagram of FIG. 7 illustrates a detailed process for determining the temperature-dependent operating frequency. At step 442, as illustrated in FIG. 7, the dynamic power-performance balancing unit 120 can determine the static power of the processing unit 112. Static power refers to the leakage power, which is the power consumed by the processing unit 112 when it is in an idle state or steady-state condition. This power dissipation is primarily due to leakage currents flowing through the transistors, even when the processing unit is not actively switching. Static power can be measured by monitoring the leakage current in the system. For instance, the leakage power monitor sensor 114B is designed to measure the leakage current flowing from the processing unit 112 in real-time. In some examples, the static power is determined by multiplying the supply voltage (to the processing unit 112) and the measured leakage current by the leakage power monitor sensor 114B. In some cases, an increase in the junction temperature of a functional block can lead to a rise in leakage current, thereby increasing the overall leakage power.

At step 443, as illustrated in FIG. 7, the dynamic power-performance balancing unit 120 can determine the dynamic power of the processing unit 112. Dynamic power refers to the power consumed during the active operation of the processing unit 112. Dynamic power is directly proportional to both the operating frequency and the supply voltage. As the operating frequency increases, the number of switching operations within the semiconductor IC components of the processing unit also increases, leading to higher power consumption. Similarly, higher supply voltage amplifies the power drawn during each switching event, further contributing to the overall dynamic power consumption.

At step 444, as illustrated in FIG. 7, the dynamic power-performance balancing unit 120 can determine the total power consumption of the processing unit 112. The total power consumption can be determined by adding the static power consumption (determined at step 442) and the dynamic power consumption (determined at step 443).

At step 445, as illustrated in FIG. 7, the dynamic power-performance balancing unit 120 can determine the junction temperature (e.g., calculated junction temperature) based at least on the total power consumption of the processing unit 112. For example, the calculated junction temperature can be determined by the following equation (Equation 1).

$$Tjunc ( junction temperature ) = Tamb ( ambient temperature ) + ( ( static power + dynamic power ) \times thermal resistance ) \qquad ( Equation 1 )$$

In some embodiments, the ambient temperature is measured by the temperature sensor 114A within the sensor array module 114. Thermal resistance refers to a measure of how well a semiconductor material resists the flow of heat. This thermal resistance can be determined based on the specific semiconductor materials used in the components of the processing unit, as it directly affects the material's ability to dissipate heat.

At step 446, as illustrated in FIG. 7, the dynamic power-performance balancing unit 120 can determine the temperature-dependent operating frequency, which is influenced by the junction temperature. As the junction temperature increases, static power also rises due to the increase in leakage current, while dynamic power remains proportional to the operating frequency. Therefore, as the junction temperature rises, the operating frequency may need to be reduced to manage power consumption and heat generation. From the dynamic power equation, as described in Equation 1, the dynamic power can be calculated, and the corresponding temperature-dependent operating frequency can be derived based on the relationship between dynamic power and frequency.

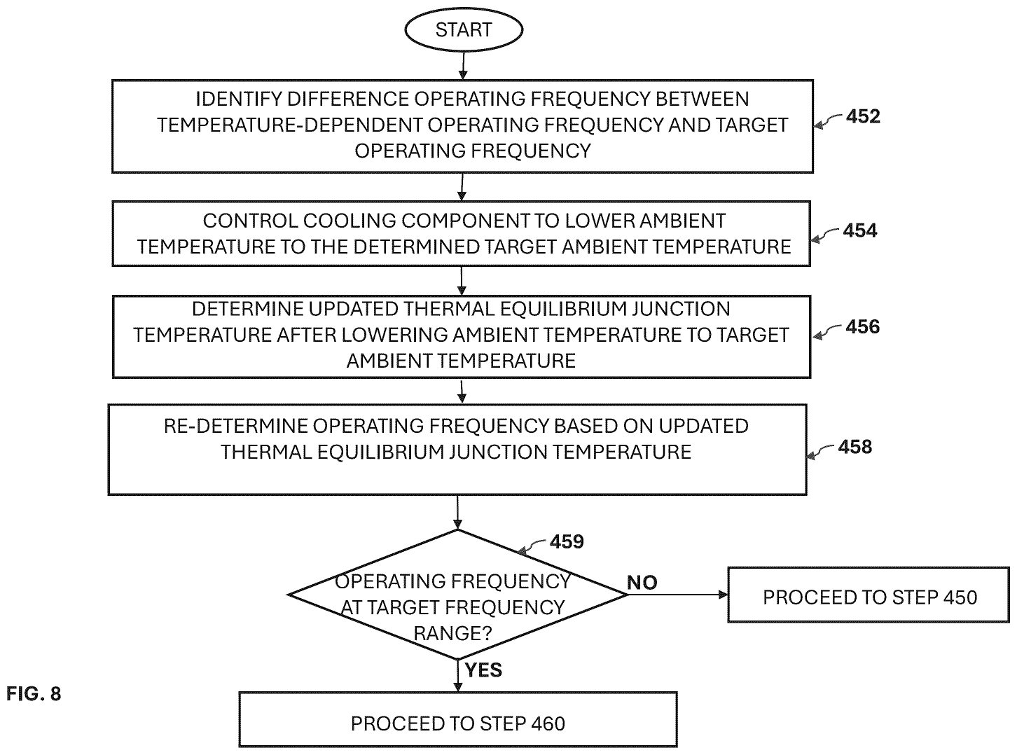

At step 450, as illustrated in FIG. 4, the dynamic power-performance balancing unit 120 can adjust the temperature-dependent operating frequency to a target operating frequency. In some cases, the step 450 (and also steps 452-459 of FIG. 8) can be performed by the processor 350 by executing instruction provided from the optimization module 330. In some embodiments, the target operating frequency can be defined an operating frequency within a threshold range of the temperature-independent operating frequency. For example, the threshold range can be 80%-100% of the temperature-independent operating frequency. For example, if the temperature-independent operating frequency is 4 GHZ, the target operating frequency range can be at or higher than 3.2 GHz. The process flow diagram of FIG. 8 illustrates detailed process for determining the temperature-dependent operating frequency.

At step 452, as illustrated in FIG. 8, the dynamic power-performance balancing unit 120 can identify the difference operating frequency between the temperature-dependent and the target operating frequencies.

At step 454, as illustrated in FIG. 8, the dynamic power-performance balancing unit 120 can control the cooling component 130 to lower the ambient temperature to a determined target ambient temperature. In some cases, the target ambient temperature is identified using Equation 1, such that lowering the ambient temperature reduces the junction temperature. As a result, dynamic power can be increased, allowing the operating frequency to rise to the target operating frequency. In some embodiments, the dynamic power-performance balancing unit 120 can adjust the thermal profile of the cooling component by executing instructions that control the cooling controller 142. For example, the fan speed can be increased when the cooling component 130 is a fan, or the liquid flow velocity can be increased when the cooling component 130 uses liquid cooling, ensuring more effective heat dissipation.

At step 456, as illustrated in FIG. 8, the dynamic power-performance balancing unit 120 can determine the updated junction temperature after reducing the ambient temperature to the target ambient temperature. In some cases, lowering the ambient temperature results in a corresponding decrease in the junction temperature (calculated junction temperature), as described in Equation 1. Additionally, since a lower junction temperature reduces static power by minimizing leakage current, this allows for an increase in dynamic power, which can further enable an increase in the operating frequency.

At step 458, as illustrated in FIG. 8, the dynamic power-performance balancing unit 120, after determining the updated junction temperature can re-determine the operating frequency by utilizing the updated junction temperature.

At step 459 of the decision block, as illustrated in FIG. 8, the dynamic power-performance balancing unit 120 can determine whether the operating frequency is at the target operating frequency. If the re-determined operating frequency is at the target operating frequency (or within the target operating frequency range), the process proceeds to step 460. If the re-determined operating frequency is outside of the target operating frequency (or outside of the target operating frequency range), the process proceeds to step 450.

At step 460, as illustrated in FIG. 4, the dynamic power-performance balancing unit 120 optimizes the supply voltage to critical path functional blocks to scale the operating frequency to the target operating frequency. In some cases, the step 460 can be performed by the processor 350 by executing instruction provided from the optimization module 330. The dynamic power-performance balancing unit 120 can also set supply voltage to the functional blocks included in the non-critical path to the operating frequency lower than the target operating frequency. In some examples, the dynamic power-performance balancing unit 120 can set, using a frequency scaling circuitry, a critical path reference frequency to the critical path functional blocks based on the target operating frequency, where the critical path reference frequency is a pulse wave clock signal (e.g., a first pulse wave clock signal generated from the frequency scaling circuitry 144). In addition, the dynamic power-performance balancing unit 120 can set, using the frequency scaling circuitry 144, a non-critical path reference frequency to the non-critical path functional blocks (e.g., remaining functional blocks not included in the critical path functional blocks) at a value less than the critical path reference frequency, where the non-critical path reference frequency is a pulse wave clock signal (e.g., a second pulse wave clock signal, different from the first wave signal, generated from the frequency scaling circuitry 144). In some examples, the critical path reference frequency can be the target operating frequency, and the non-critical path reference frequency can be the frequency lower than the target operating frequency or the operating frequency corresponding to the idling state of the functional blocks included in the non-critical path. In some examples, the dynamic power-performance balancing unit 120 can set, using a voltage scaling circuitry 146, a critical path voltage to the critical path functional blocks based on the supply voltage (e.g., a magnitude of first supply voltage) that can generate the target operating frequency (e.g., supply voltage corresponding to the target operating frequency). In addition, the dynamic power-performance balancing unit 120 can set, using the voltage scaling circuitry 146, a non-critical path voltage (e.g., with a magnitude of second supply voltage lower than the magnitude of first supply voltage) to the non-critical path functional blocks.

At step 470, as illustrated in FIG. 4, the dynamic power-performance balancing unit 120 optimizes the ramping rate when scaling the voltage and frequency. In some cases, the step 470 can be performed by the processor 350 by executing instruction provided from the ramping rate optimization module 332. Optimizing the ramping rate is to prevent sudden changes in voltage or frequency, which could otherwise cause physical stress on the semiconductor components. The ramping rate is pre-defined based on the specifications of the semiconductor components within each functional block to ensure safe and efficient scaling.

### Alternative Method for Dynamically Scaling Frequency and Voltage Based on Workload

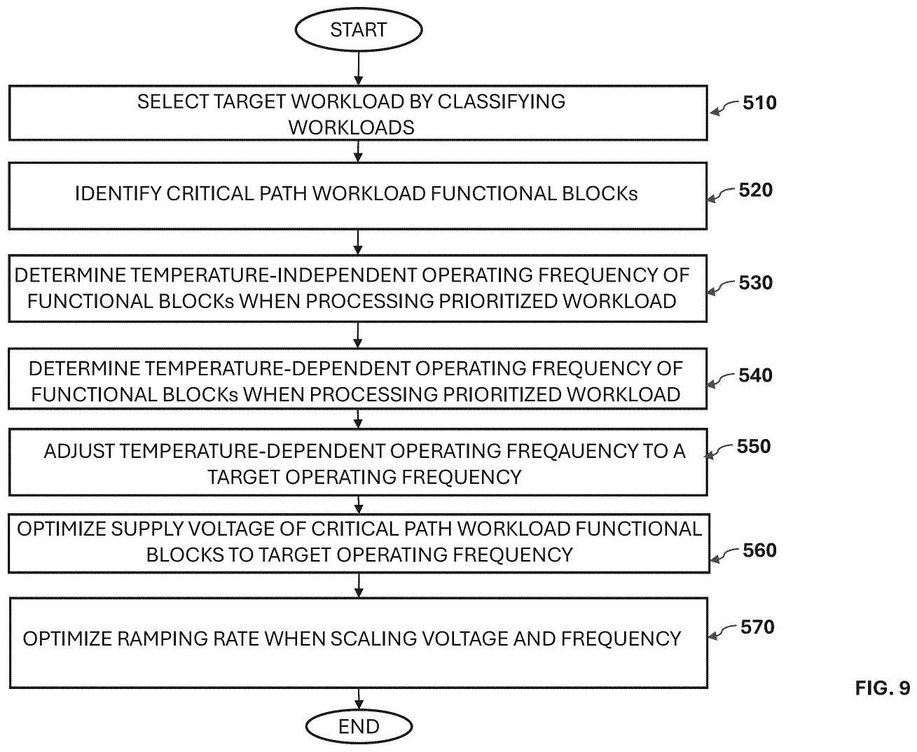

FIG. 9 illustrates an alternative method for dynamically scaling the frequency and voltage based on prioritized workloads.

At step 510, the dynamic power-performance balancing unit 120 is configured to select a target workload by classifying incoming workloads. In some cases, the step 510 can be performed by the processor 350 by executing instruction provided from the incoming workloads analysis module 324 and the machine learning module 322 as illustrated in FIG. 3. In some embodiments, The dynamic power-performance balancing unit 120 classifies workloads by prioritizing them according to predicted resource usage for each functional block in the processing unit 112 per individual workload. For instance, when multiple workloads arrive simultaneously, the dynamic power-performance balancing unit 120 can prioritize them based on the expected resource usage of the processing unit 112. The workload requiring the highest resource utilization among the incoming tasks is identified as the target workload. In this scenario, the dynamic power-performance balancing unit 120 can determine the appropriate operating frequency and supply voltage for all functional blocks involved in processing the target workload. For the other workloads, the operating frequency and supply voltage supplied to the functional blocks can be lower than those used for processing the target workload.

In some embodiments, the dynamic power-performance balancing unit 120 can predict incoming workloads. In various embodiments, the dynamic power-performance balancing unit 120 can utilize the machine learning module 322 to predict the incoming workloads. For example, the machine learning module 322 (e.g., implementing the RNN) can be trained to predict the temporal sequence of what application to be executed by the processing unit 112. In some examples, the prediction of the temporal sequence is based on historical usage of the processing unit 112. In various embodiments, each predicted application can include one or more workloads to be processed by the processing unit 112.

In some embodiments, the dynamic power-performance balancing unit 120 can predict expected usage of resources of each functional block. In various embodiments, predicting the expected usage of each functional block can be performed by utilizing the machine learning module 322, such that machine learning module 322 can predict the expected usage of resources of each functional block based on historical application usage data and identifying usage patterns of each functional block to be expended its resources to process each incoming workload.

In some embodiments, the dynamic power-performance balancing unit 120 can prioritize the incoming workloads based on predicted expected usage of resources of each functional block. The prioritization is based on the expected usage of each functional block. For example, if workload A is predicted to use 70% of the resources in the computing block 112A and first memory block 112B, while workload B is expected to use 60%, workload A would be prioritized over workload B. This prioritized workload is referred to as the target workload. For the purpose of description, the prioritized workload (e.g., the workload A) can refer to as a target workload. After prioritizing the incoming workloads based on the predicted usage of each functional blocks, the process proceeds to step 420.

In step 520, the dynamic power-performance balancing unit 120 identifies functional blocks when utilized to process the prioritized workload and when utilized to process the non-prioritized workloads. In some cases, the step 520 can be performed by the processor 350 by executing instructions provided from the incoming workloads analysis module 324. The functional blocks used for processing prioritized workloads are referred to as critical path workload functional blocks, while the functional blocks involved in processing non-prioritized workloads are referred to as non-critical path workload functional blocks.

At step 530, the dynamic power-performance balancing unit 120 determines the temperature-independent operating frequency of functional blocks when processing prioritized workload. In some cases, the step 530 can be performed by the processor 350 by executing instruction provided from the operating frequency determination module 326. In some embodiments, the dynamic power-performance balancing unit 120 determines the minimum latency for the functional blocks to process the prioritized workload. Such minimum latency can provide an ideal operating frequency based on the relationship that the lower minimum latency may demand the higher operating frequency of the functional blocks.

At step 540, the dynamic power-performance balancing unit 120 determines the temperature-dependent operating frequency of the critical path workload functional blocks. In some cases, the step 540 can be performed by the processor 350 by executing instruction provided from the thermal domain analysis module 328. In various embodiments, thermal effects, such as an increased junction temperature in the critical path workload functional blocks, can result in a reduction of their operating frequency. For instance, as the junction temperature rises, leakage power also increases due to the heat generated by the higher temperature. This increase in leakage power directly impacts the operating frequency, leading to a decrease in performance. The resulting reduced frequency is referred to as the temperature-dependent operating frequency.

In some embodiments, the dynamic power-performance balancing unit 120 can determine the static power of the processing unit 112. Static power refers to the leakage power, which is the power consumed by the processing unit 112 when it is in an idle state or steady-state condition. This power dissipation is primarily due to leakage currents flowing through the transistors, even when the processing unit is not actively switching. Static power can be measured by monitoring the leakage current in the system. For instance, the leakage power monitor sensor 114B is designed to measure the leakage current flowing from the processing unit 112 in real-time. In some cases, an increase in the junction temperature of a functional block can lead to a rise in leakage current, thereby increasing the overall leakage power.

In some embodiments, the dynamic power-performance balancing unit 120 can determine the dynamic power of the processing unit 112. Dynamic power refers to the power consumed during the active operation of the processing unit 112. Dynamic power is directly proportional to both the operating frequency and the supply voltage. As the operating frequency increases, the number of switching operations within the semiconductor IC components of the processing unit also increases, leading to higher power consumption. Similarly, higher supply voltage amplifies the power drawn during each switching event, further contributing to the overall dynamic power consumption.

In some embodiments, the dynamic power-performance balancing unit 120 can determine the total power consumption of the processing unit 112. The total power consumption can be determined by adding the static power consumption (determined at step 442) and the dynamic power consumption (determined at step 443).

In some embodiments, the dynamic power-performance balancing unit 120 can determine the junction temperature (e.g., junction temperature) by calculating it based at least on the determined total power consumption of the processing unit 112. For example, the thermal equilibrium junction temperature can be determined by the above Equation 1.

In some embodiments, the ambient temperature is measured by the temperature sensor 114A within the sensor array module 114. Thermal resistance refers to a measure of how well a semiconductor material resists the flow of heat. This thermal resistance can be determined based on the specific semiconductor materials used in the components of the processing unit, as it directly affects the material's ability to dissipate heat.

In some embodiments, the dynamic power-performance balancing unit 120 can determine the temperature-dependent operating frequency, which is influenced by the junction temperature. As the junction temperature increases, static power also rises due to the increase in leakage current, while dynamic power remains proportional to the operating frequency. Therefore, as the junction temperature rises, the operating frequency may need to be reduced to manage power consumption and heat generation. From the dynamic power equation, as described in Equation 1, the dynamic power can be calculated, and the corresponding temperature-dependent operating frequency can be derived based on the relationship between dynamic power and frequency.

At step 550, the dynamic power-performance balancing unit 120 can adjust the temperature-dependent operating frequency to a target operating frequency. In some cases, the step 550 can be performed by the processor 350 by executing instruction provided from the optimization module 330. In some embodiments, the target operating frequency refers to an operating frequency within a threshold range of the temperature-independent operating frequency. For example, the threshold range can be 80%-100% of the temperature-independent operating frequency. For example, if the temperature-independent operating frequency is 4 GHz, the target operating frequency range can be at or higher than 3.2 GHZ. The process flow diagram of FIG. 8 illustrates a detailed process for determining the temperature-dependent operating frequency.

In some embodiments, the dynamic power-performance balancing unit 120 can identify the difference operating frequency between the temperature-dependent and the target operating frequencies.

In some embodiments, the dynamic power-performance balancing unit 120 can control the cooling component 130 to lower the ambient temperature to a determined target ambient temperature. In some cases, the target ambient temperature is identified using Equation 1, such that lowering the ambient temperature reduces the junction temperature. As a result, dynamic power can be increased, allowing the operating frequency to rise to the target operating frequency. In some embodiments, the dynamic power-performance balancing unit 120 can adjust the thermal profile of the cooling component by executing instructions that control the cooling controller 142. For example, the fan speed can be increased when the cooling component 130 is a fan, or the liquid flow velocity can be increased when the cooling component 130 uses liquid cooling, ensuring more effective heat dissipation.

In some embodiments, the dynamic power-performance balancing unit 120 can determine the updated junction temperature after reducing the ambient temperature to the target ambient temperature. In some cases, lowering the ambient temperature results in a corresponding decrease in the junction temperature (e.g., calculated junction temperature) in accordance with Equation 1. Additionally, since a lower junction temperature reduces static power by minimizing leakage current, this allows for an increase in dynamic power, which can further enable an increase in the operating frequency.

In some embodiments, the dynamic power-performance balancing unit 120, after determining the updated junction temperature can re-determine the operating frequency by utilizing the updated junction temperature.

At step 560, the dynamic power-performance balancing unit 120 optimizes the supply voltage to critical path workload functional blocks to scale the operating frequency to the target operating frequency. In some cases, the step 560 can be performed by the processor 350 by executing instruction provided from the optimization module 330. The dynamic power-performance balancing unit 120 can also set supply voltage to the non-critical path workload functional blocks lower than the target operating frequency. In some examples, the dynamic power-performance balancing unit 120 can set, using a frequency scaling circuitry 144, a critical path reference frequency to the critical path workload functional blocks based on the target operating frequency, where the critical path reference frequency is a pulse wave clock signal (e.g., a first pulse wave clock signal generated from the frequency scaling circuitry 144). In addition, the dynamic power-performance balancing unit 120 can set, using the frequency scaling circuitry, a non-critical path reference frequency to the non-critical path workload functional blocks (e.g., remaining functional blocks not included in the critical path functional blocks) at a value less than the critical path reference frequency, where the non-critical path reference frequency is a pulse wave clock signal (e.g., a second pulse wave clock signal, different from the first wave signal, generated from the frequency scaling circuitry 144). In some examples, the critical path reference frequency can be the target operating frequency, and the non-critical path reference frequency can be the frequency lower than the target operating frequency or the operating frequency corresponding to the idling state of the functional blocks included in the non-critical path. In some examples, the dynamic power-performance balancing unit 120 can set, using a voltage scaling circuitry 146, a critical path voltage to the critical path workload functional blocks based on the supply voltage (e.g., a magnitude of first supply voltage) that can generate the target operating frequency (e.g., supply voltage corresponding to the target operating frequency). In addition, the dynamic power-performance balancing unit 120 can set, using the voltage scaling circuitry 146, a non-critical path voltage (e.g., with a magnitude of second supply voltage lower than the magnitude of first supply voltage) to the non-critical path workload functional blocks.

At step 570, as illustrated in FIG. 4, the dynamic power-performance balancing unit 120 optimizes the ramping rate when scaling the voltage and frequency. In some cases, the step 570 can be performed by the processor 350 by executing instruction provided from the ramping rate optimization module 332. Optimizing the ramping rate is to prevent sudden changes in voltage or frequency, which could otherwise cause physical stress on the semiconductor components. The ramping rate is pre-defined based on the specifications of the semiconductor components within each functional block to ensure safe and efficient scaling.

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled,” as generally used herein, refers to two or more elements that may be either directly connected, or connected by way of one or more intermediate elements. Likewise, the word “connected,” as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Moreover, as used herein, when a first element is described as being “on” or “over” a second element, the first element may be directly on or over the second element, such that the first and second elements directly contact, or the first element may be indirectly on or over the second element such that one or more elements intervene between the first and second elements. Where the context permits, words in the above Detailed Description using the singular or plural number may also include the plural or singular number, respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments.

While certain embodiments have been described, these embodiments have been presented by way of example only and are not intended to limit the scope of the disclosure. Indeed, the novel apparatus, methods, and systems described herein may be embodied in a variety of other forms; furthermore, various omissions, substitutions, and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and acts of the various embodiments described above can be combined to provide further embodiments. The accompanying claims and their equivalents are intended to cover such forms or modifications as would fall within the scope and spirit of the disclosure.

1.-11. (canceled)

12. An integrated circuit (IC) device comprising:
a computing unit comprising:
a processing unit comprising a plurality of functional blocks; and
a sensor array module comprising at least a temperature measurement sensor and a leakage power measurement sensor;
a cooling component configured to manage a temperature of the processing unit;
a controller comprising a cooling controller circuitry and a voltage scaling circuitry;
a memory unit communicatively coupled with the computing unit and the controller, the memory unit having stored thereon instructions to perform:
classifying, using a recurrent neural network stored in the memory unit, a plurality of workloads to be processed by the processing unit by prioritizing the plurality of workloads according to expected resources to be expended by different functional blocks of the processing unit;
selecting a target workload from the plurality of workloads based on classification results of the plurality of workloads;
identifying a critical path within the plurality of functional blocks, wherein the critical path includes one or more functional blocks utilized to process the target workload;
determining a temperature-independent theoretical operating frequency for the one or more functional blocks;
determining a temperature-dependent operating frequency for the one or more functional blocks based on a calculated junction temperature of the processing unit and a total power consumption of the processing unit, wherein the calculated junction temperature is determined in part from an ambient temperature measured using the temperature sensor, and wherein the total power consumption corresponds to a sum of total static power and total dynamic power expended by the processing unit, wherein the total static power is determined from a total leakage current measured from the processing unit using the leakage power measurement sensor;
adjusting, by managing the temperature of the processing unit using the cooling component, the temperature-dependent operating frequency to a target operating frequency having a value within a predetermined difference from the temperature-independent theoretical operating;
setting, using the voltage scaling circuitry, a critical path supply voltage for the one or more functional blocks based on the target operating frequency; and
setting, using the voltage scaling circuitry, a non-critical path supply voltage for remaining functional blocks at a value less than the critical path supply voltage.

13. The integrated IC device of claim 12, wherein setting the critical path supply voltage and the non-critical path supply voltage are performed by adjusting the supply voltages for each of the functional blocks, wherein adjusting the supply voltage for each of the functional blocks causes adjusting dynamic power for each of the functional blocks.

14. The integrated IC device of claim 12, wherein the memory unit further comprises instructions to perform:
determining a ramping rate of the critical path supply voltage by pre-defining a time duration to reach the critical path supply voltage; and
determining a ramping rate of the non-critical supply voltage by pre-defining a time duration to reach the non-critical path supply voltage.

15. The integrated IC device of claim 12, wherein the controller further comprises a frequency scaling circuitry, wherein the frequency scaling circuitry comprises at least one of an oscillator, a clock generator, and a phase-locked loop.

16. The integrated IC device of claim 15, wherein the memory unit further comprises instructions to perform:
setting, by generating a first pulse wave clock signal using the frequency scaling circuitry, a critical path reference frequency based on the target operating frequency, wherein the first pulse wave clock signal is equivalent to the critical path reference frequency; and
setting, by generating a second pulse wave clock signal using the frequency scaling circuitry, a non-critical path reference frequency for the remaining functional blocks at a value less than the critical path reference frequency, wherein the second pulse wave clock signal is equivalent to the non-critical path reference frequency.

17. The integrated IC device of claim 16, wherein the memory unit further comprises instructions to perform:
determining a ramping rate of a reference frequency by pre-defining a time duration to reach the critical path reference frequency; and
determining a ramping rate of a reference frequency by pre-defining a time duration to reach the non-critical path reference frequency.

18. The integrated IC device of claim 12, wherein the voltage scaling circuitry comprises a voltage regulator module.

19. The integrated IC device of claim 12, wherein the recurrent neural network is trained to predict the expected resources to be expended by the different functional blocks.

20. The integrated IC device of claim 12, wherein the processing unit comprises any one of a central processing unit (CPU), a graphic processing unit (GPU), a tensor processing unit (TPU), and a system on chip (SOC).

21. (canceled)

22. The integrated IC device of claim 12, wherein the plurality of functional blocks comprises one or more computing blocks and one or more memory blocks.

23. The integrated IC device of claim 12, wherein the one or more functional blocks are determined by identifying a data communication path for processing the target workload within the plurality of functional blocks.

24. A method of dynamically balancing power and performance of a processing unit configured for machine learning based on real-time sensor data and thermal data, the method comprising:
receiving a plurality of workloads to be processed by the processing unit;
selecting a target workload by classifying, using a recurrent neural network, the workloads according to expected resources to be expended by different functional blocks of the processing unit;
identifying critical path functional blocks and non-critical path functional blocks among a plurality of functional blocks implemented in the processing unit, the identification based at least on a threshold level of resource utilization for each functional block to process the target workload;
determining a temperature-independent theoretical operating frequency for the critical path functional blocks;
determining a temperature-dependent operating frequency for the target workload based on a junction temperature of the processing unit, the junction temperature determined from a temperature sensor coupled to the processing unit and total power consumed by the processing unit;
adjusting the temperature-dependent operating frequency to a target operating frequency having a value within a predetermined difference from the temperature-independent theoretical operating frequency by actively cooling the processing unit using a cooling unit coupled to the processing unit;
setting, using a voltage scaling circuitry, a critical path supply voltage for the one or more functional blocks based on the target operating frequency; and
setting, using a voltage scaling circuitry, a non-critical path supply voltage for remaining functional blocks at a value less than the critical path supply voltage.

25. The method of claim 24, wherein the different functional blocks comprise an arithmetic logic unit (ALU), a cache memory, a main memory, an input and output (I/O) device, a bus, a control unit, and an instruction set architecture (ISA).

26. The method of claim 24, wherein determining the temperature-independent theoretical operating frequency comprises determining an operating frequency for processing the target workload that is not lowered by an elevated temperature.

27. The method of claim 24, wherein the total power corresponds to a sum of total static power and total dynamic power expended by the processing unit, and wherein the total static power is determined from a total leakage current measured from the processing unit using a sensor array module provided in the processing unit.

28. (canceled)

29. The method of claim 24, wherein the temperature-dependent operating frequency is determined from an electro-thermally-coupled power equation.

30. The method of claim 24, wherein the method further comprises, after setting the critical path supply voltage and the non-critical path supply voltage:
determining a ramping rate of the critical path supply voltage by pre-defining a time duration to reach the critical path supply voltage; and
determining a ramping rate of the non-critical path supply voltage by pre-defining a time duration to reach the non-critical path supply voltage.

31. The method of claim 24, further comprising:
setting, by generating a first pulse wave clock signal using the frequency scaling circuitry, a critical path reference frequency based on the target operating frequency, wherein the first pulse wave clock signal is equivalent to the critical path reference frequency; and
setting, by generating a second pulse wave clock signal using the frequency scaling circuitry, a non-critical path reference frequency for remaining functional blocks at a value less than the critical path reference frequency, wherein the second pulse wave clock signal is equivalent to the non-critical path reference frequency.

32. The method of claim 31, further comprising:
determining a ramping rate of a reference clock signal by pre-defining a time duration to reach the critical path functional blocks reference frequency; and
determining a ramping rate of the reference clock signal by pre-defining a time duration to reach the non-critical path reference frequency.

33. The method of claim 24, wherein the recurrent neural network is trained to predict the expected resources to be expended by the different functional blocks.

34. The method of claim 24, wherein the processing unit comprises a central processing unit (CPU), a graphic processing unit (GPU), a tensor processing unit (TPU), or a system on chip (SOC).
